(19) United States
(12) Patent Application Publication
(10) Pub. No.: US 2016/0057544 A1
(43) Pub. Date: Feb. 25, 2016

(54) Carbon Nanotube Copper Composite Wire for Acoustic Applications

(71) Applicant: Plugged Inc., Austin, TX (US)

(72) Inventor: ANAND CHAMARTHY, Plano, TX (US)

(21) Appl. No.: 14/831,401

(22) Filed: Aug. 20, 2015

Related U.S. Application Data
(60) Provisional application No. 62/040,411, filed on Aug. 21, 2014.

(51) Int. Cl. H04R 9/04

(52) U.S. Cl. CPC H04R 9/046

(57) ABSTRACT

Embodiments of apparatuses, systems, and methods for acoustic energy conversion are described. The acoustic energy conversion may be achieved using an acoustic wire in a voice coil. The acoustic wire may be a carbon nanotube copper composite voice coil wire. In one technique, the acoustic wire may be formed by using a copper-in-tube process that includes use of an electroless deposition process. In another technique, the acoustic wire may be formed via an electrophoretic deposition process.

### CROSS REFERENCES

The present application for patent claims priority to U.S. Provisional Patent Application No. 62/040,411 by Chamarthy entitled “CNT-Cu Composite Voice Coil,” filed Aug. 21, 2014, the entirety of which is incorporated by reference herein.

### BACKGROUND

The present disclosure generally relates to acoustic energy conversion, and more specifically to a voice coil that includes a carbon nanotube copper composite.

Many loudspeaker drivers use a lightweight diaphragm connected to a rigid basket that constrains a voice coil to move axially through a cylindrical magnetic gap. When an electrical signal is applied to the voice coil, a magnetic field is created by the electric current in the voice coil, making it a variable electromagnet. The voice coil, acting as a variable electromagnet, and the driver's permanent magnet may interact so as to generate a mechanical force that causes the coil (and thus the attached diaphragm) to move back and forth, thereby reproducing sound under the control of the applied electrical signal coming from an amplifier.

The wire in a voice coil is often made of copper. Sometimes other materials may be used, such as aluminum or silver. In some instances, copper-clad aluminum may be used. With use of each of these materials, the voice coils are generally no more than approximately five percent efficient. In other words, using the traditional materials for a voice coil, only about five percent of the applied electrical energy is converted to sound. The rest of the applied electrical energy is dissipated as heat from the voice coil.

Therefore, raising the efficiency of voice coils by improving the characteristics of an acoustic wire used in voice coils will be beneficial.

### BRIEF DESCRIPTION OF THE DRAWINGS

FIG. 1 is a schematic illustration of a speaker assembly having a voice coil, in accordance with aspects of the present disclosure.

FIG. 2 is a block diagram of a voice coil included within a loudspeaker driver, in accordance with aspects of the present disclosure.

FIG. 3 is a perspective view of an acoustic wire, in accordance with aspects of the present disclosure.

FIGS. 4-6 are flowcharts illustrating methods of forming an acoustic wire, in accordance with aspects of the present disclosure.

### DETAILED DESCRIPTION

Described herein are apparatuses, systems, and methods for acoustic energy conversion. The acoustic energy conversion may be achieved using an acoustic wire in a voice coil. The acoustic wire may be a carbon nanotube copper composite voice coil wire. The carbon nanotube copper composite voice coil wire may be formed using various techniques. In one technique, the voice coil wire may be formed by using a copper-in-tube process that includes use of an electroless deposition process. In another technique, the voice coil wire may be formed via an electrophoretic deposition process.

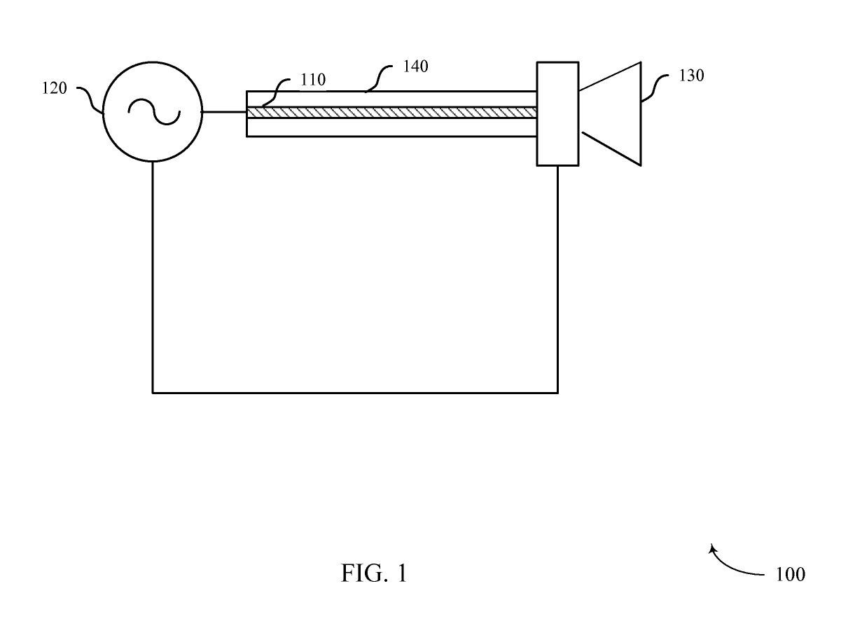

Turning now to the figures, FIG. 1 illustrates a schematic illustration of a speaker assembly 100 having a voice coil 110. The speaker assembly 100 includes an AC source 120 that provides a current to be passed through a voice coil 110 to a loudspeaker 130. The voice coil 110 may act as a variable electromagnet and, in combination with a permanent magnet of a loudspeaker driver 140, may generate a mechanical force that causes the voice coil 110 (and an attached diaphragm within the loudspeaker driver 140) to move back and forth. The movement of the diaphragm back and forth reproduces sound under the control of an applied electrical signal coming from an amplifier.

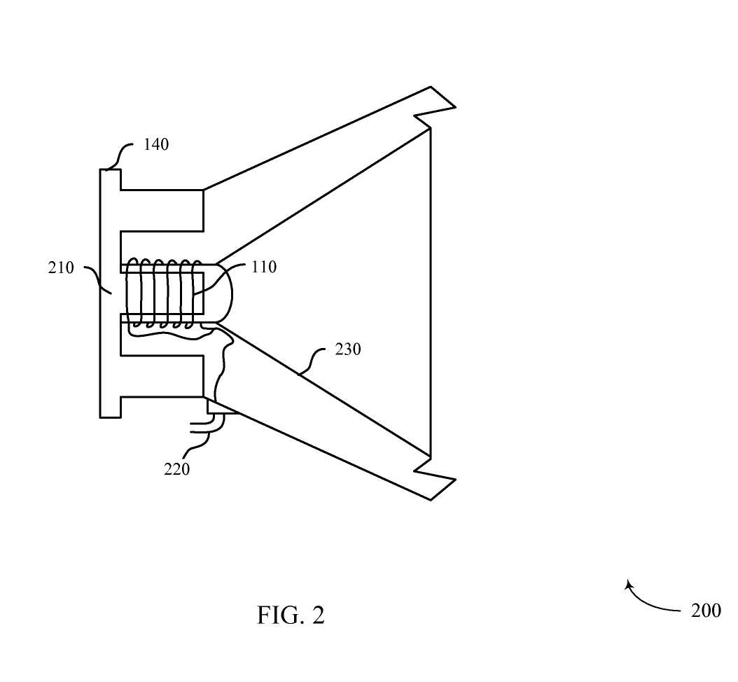

FIG. 2 illustrates a block diagram 200 of a voice coil 110 that is included within a loudspeaker driver 140. The loudspeaker driver 140 may include a permanent magnet 210. The voice coil 110 may include an acoustic wire that circumscribes at least a portion of the permanent magnet 210 so that the voice coil 110 and the permanent magnet 210 may interact with each other. A current may be driven through the voice coil 110 via electrical leads 220. By driving a current through the voice coil 110, a magnetic field is produced. The magnetic field may cause the voice coil 110 to react to the magnetic field from the permanent magnet 210 fixed to the loudspeaker driver 140. The resulting movement of the voice coil 110 results in movement of a cone 230 of the loudspeaker 130. By applying an audio waveform (in the form of an AC source) to the voice coil 110, the cone 230 may reproduce sound pressure waves corresponding to an original input signal.

The voice coil 110 is made of an acoustic wire. The wire in a voice coil is often made of copper. Copper wire generally provides an easily manufactured, general purpose voice coil 110 at a reasonable cost. Aluminum wire may be used when extended high frequency response is desired, as an aluminum voice coil has approximately one-third the density of copper, but approximately two-thirds the electrical conductivity of copper. Copper-clad aluminum (CCA) may be used to overcome various manufacturing challenges associated with use of pure aluminum.

The efficiency of a voice coil material is based on the coil's resistivity and its density: efficiency is equal to the product of the coil's resistivity and density. The lower the product, the more current may be provided for an equivalent mass. A current benchmark is that resulting from use of CCA, which may be calculated by multiplying CCA's resistivity (2.67 Ohm cm) with its density (3.63 g/cm̂3) to yield a product of 9.69.

Voice coils are also susceptible to thermal compression. As temperature increases (which may occur as current is passed through the voice coil in a phenomenon known as Joule Heating), the resistance (and subsequently, the impedance) of the voice coil increases. As a result, the acoustic output (measured in decibels) of a voice coil may decrease over operation time. The thermal compression of a voice coil is dependent on a material's temperature coefficient of resistivity (TCR). Copper, aluminum, and CCA all have the same TCR (of approximately 0.004 per ° C.). This means that a voice coil made of these materials will have its resistance double as the voice coil reaches 250° C., decreasing a speaker's output by a similar factor (a decrease of approximately 5 dB).

For reference, Table 1 below includes various properties of different materials that may be used for voice coils, including copper, aluminum, CCA 10%, CCA 15%, and high tension (HT) CCA.

TABLE 1
Typical Values of Voice Coil Materials

| | | | | CCA | CCA | |
|---|---|---|---|---|---|---|
| | | Cu | Al | 10% | 15% | HTCCA |
| % of copper | [%] | 100 | 0 | 10 | 15 | 15 |
| by volume | | | | | | |
| Density | [kg/dm³] | 8.9 | 2.7 | 3.3 | 3.6 | 3.6 |
| Resistance | [%] | 100 | 62 | 65 | 68 | 60 |
| (IACS) | | | | | | |
| Conductivity | [S*m/mm²] | 58.5 | 35.85 | 37.7 | 39.2 | 35.0 |
| Resistivity | [Ohm*mm²/m] | 0.0171 | 0.0279 | 0.0265 | 0.0255 | 0.0286 |
| Solderability | [−] | Good | No | Good | Good | Good |
| | | | conventional | | | |
| | | | soldering | | | |
| Tensile | [N/mm²] | 220-270 | 120-140 | 130-180 | 170-230 | 230-280 |
| strength | | | | | | |

Improving upon the efficiency benchmark set by CCA may be desirable. Additionally, achieving a lower TCR than that of copper, aluminum, and CCA may also be desirable. Finally, achieving a higher ampacity than copper in order to allow packing of more wire in a same space may also be desirable.

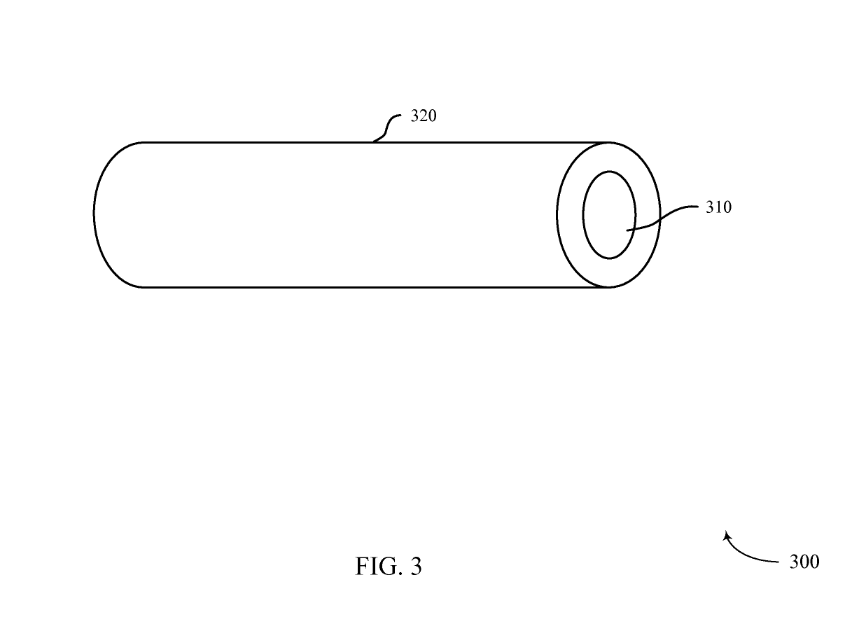

FIG. 3 illustrates an acoustic wire 300 that may be used in an improved voice coil, or a voice coil that improves upon the characteristics of pure copper, pure aluminum, or CCA. The acoustic wire 300 may include a core 310 extending along a longitudinal axis. The core 310 may include a carbon nanotube (CNT) copper composite. The core 310 may also be circumscribed by a copper layer 320. The acoustic wire 300 may thus be a lightweight CNT copper composite acoustic wire that includes high thermal and electrical conductivity. For a CNT copper composite acoustic wire, the conductivity fluctuation as a function of temperature is smaller than that for copper, thus leading to significantly less thermal compression and flux modulation compression, and thus directly resulting in improved acoustic conversion efficiency. The CNT copper composite acoustic wire may be produced using various techniques described herein.

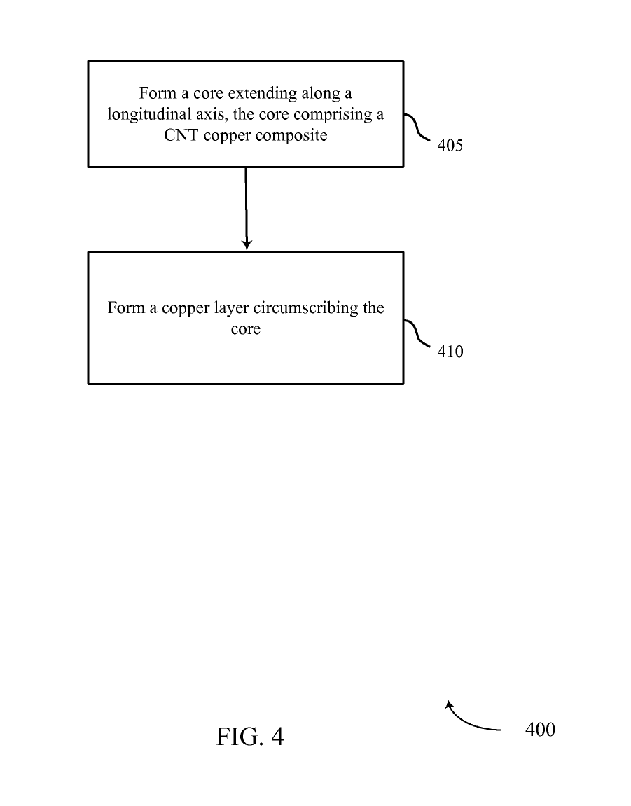

FIG. 4 illustrates one method 400 for producing the CNT copper composite acoustic wire. The method 400 of FIG. 4 may produce an acoustic wire, such as acoustic wire 300 of FIG. 3. The produced acoustic wire may be used in a voice coil, such as voice coil 110 of FIGS. 1 and 2.

At block 405, method 400 may include forming a core extending along a longitudinal axis, the core comprising a CNT copper composite. The operations of block 405 may include any number of ways to form the CNT copper composite core. For example, the core may be formed by using electrophoretic deposition, which may be used to create the CNT copper composite, as described in detail below. Alternatively, the core may be formed by using electroless deposition, as also described in detail below.

At block 410, method 400 may include forming a copper layer circumscribing the core. The operations of block 410 may include any number of ways to form the copper layer around the core. For example, the copper layer may be formed by using organic and/or aqueous electroplating, as described in detail below. Alternatively, the copper layer may be formed by using a powder-in-a-tube process, as also described in detail below.

In one example of method 400, forming the core at block 405 may include forming a plurality of CNTs on a substrate. The plurality of CNTs may be vertically-aligned and may comprise a single wall. A shear force may be provided to the plurality of CNTs in order to change the alignment of the CNTs to a horizontal alignment that corresponds with the longitudinal axis of the acoustic wire. Once the alignment of the CNTs has been changed to a horizontal alignment, the plurality of CNTs may be densified. Densifying the CNTs may include bathing the plurality of CNTs in a solution of copper acetate dissolved in acetoneitrile, for example.

Continuing the example, forming the copper layer at block 410 may include electroplating copper onto the core. For example, an organic solution may be used to nucleate copper seeds onto a surface of the core. An aqueous solution may then be used to grow the copper seeds in order to fill any mesopores of the core. After each electrodeposition (both the organic and the aqueous electroplating), the acoustic wire may be washed with pure acetoneitrile and then dried using a vacuum desiccator. The washing and drying may be followed by a heating in a tube furnace. The heating and subsequent cooling may be carried out under a controlled flow of gas such as hydrogen gas.

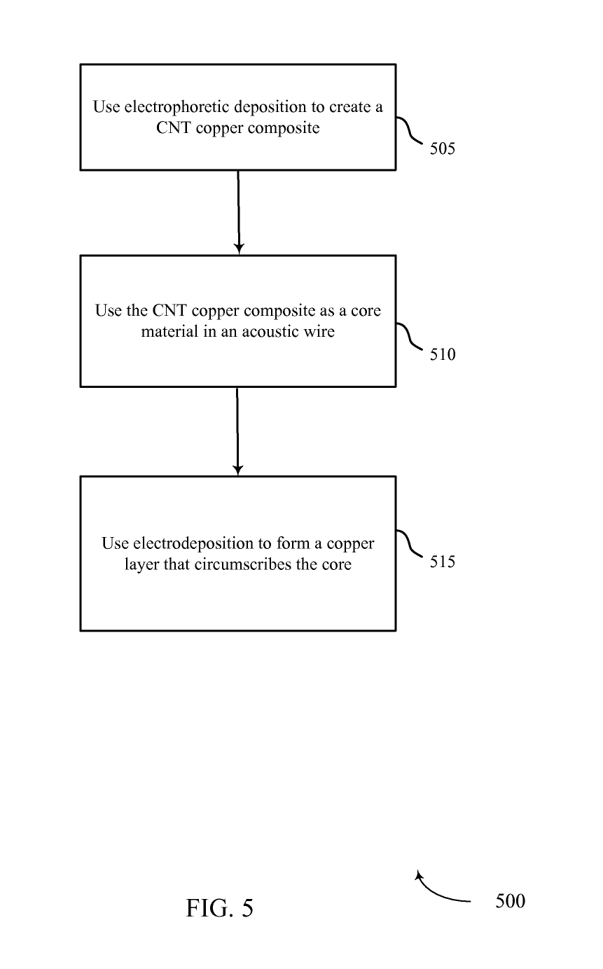

FIG. 5 illustrates another method 500 for producing the CNT copper composite acoustic wire. The method 500 of FIG. 5 may produce an acoustic wire, such as acoustic wire 300 of FIG. 3. The produced acoustic wire may be used in a voice coil, such as voice coil 110 of FIGS. 1 and 2.

At block 505, method 500 may include using electrophoretic deposition to create a CNT copper composite. The CNT copper composite may include CNT-coated copper powder or foil. This may be done, for example, by applying an electric field to charged CNTs dispersed in a solvent or aqueous medium so as to compel the charged CNTs to migrate towards a copper electrode. The charged CNTs may collect and adhere to a surface of the copper electrode so as to form a CNT coating on the copper powder or foil.

At block 510, method 500 may include using the CNT copper composite as a core material in an acoustic wire.

At block 515, method 500 may include using electrodeposition to form a copper layer that circumscribes the core. Organic and aqueous electroplating may be used, for example. Organic electroplating may be used by wetting the CNT copper composite core with copper ions in an organic solution in order to nucleate copper seeds on the core surface. Aqueous electroplating may be used to grow the copper seeds until all mesopores are filled, thus creating the copper layer.

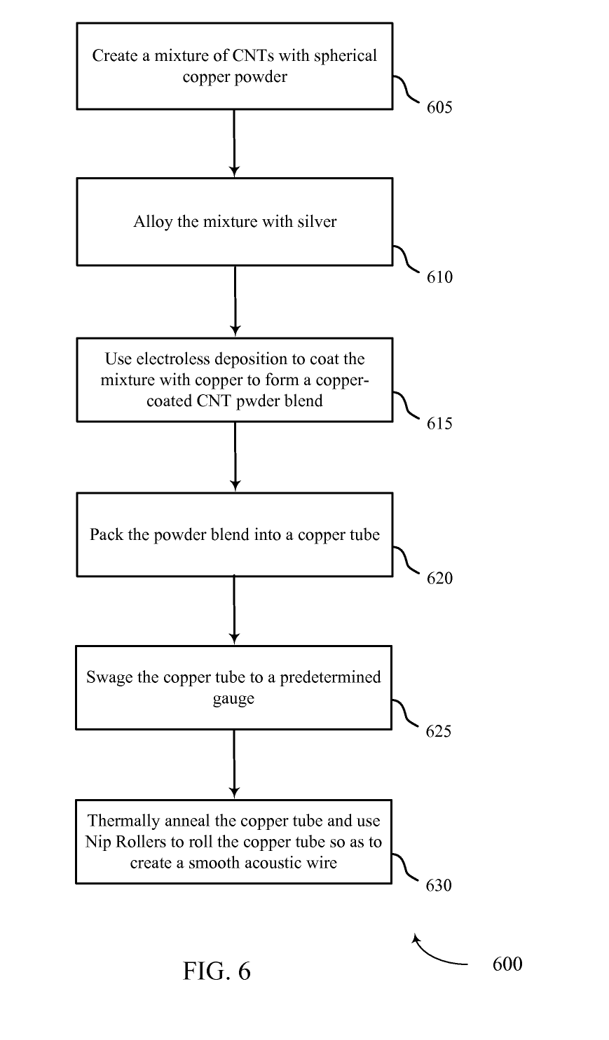

FIG. 6 illustrates another method 600 for producing the CNT copper composite acoustic wire. The method 600 of FIG. 6 may produce an acoustic wire, such as acoustic wire 300 of FIG. 3. The produced acoustic wire may be used in a voice coil, such as voice coil 110 of FIGS. 1 and 2.

At block 605, method 600 may include creating a mixture of CNTs with spherical copper powder. The mixture may be, for example, in an electroplating bath that includes the CNTs and copper sulfate and formaldehyde, for example.

At block 610, the method 600 may include alloying the mixture with silver. The silver may be added by electroless deposition. The silver may be added so as to increase conductivity even further.

At block 615, the method 600 may include using electroless deposition to coat the mixture with copper to form a copper-coated CNT powder blend. Electroless deposition may result in a uniform coating of copper on all of the available surfaces. In one example, using electroless deposition may include creating a plurality of copper-coated CNT powder blends, with each of the blends having a different ratio of copper to copper-coated CNTs. Some example ratios of copper to copper-coated CNTs may include 4:1, 8:1, 16:1, and 32:1. Other ratios may be used as well. The plurality of different powder blends may be consolidated via hot isostatic pressing or cold isostatic pressing to create a consolidated powder. Alternatively, a single copper-coated CNT powder blend may be used. The selected blend may have an overall composition of from thirty to sixty percent CNT. In some examples, the selected blend may have an overall composition of from forty to fifty percent CNT.

At block 620, the method 600 may include packing the powder blend (either a single powder blend or a consolidated powder blend) into a copper tube which may serve as a circumscribing copper layer. In one example, the copper tube may be a 10100 oxygen-free high-conductivity (OFHC) copper tube. The powder blend may be packed such that the copper-coated CNTs are aligned along the longitudinal axis of the copper tube.

At block 625, the method 600 may include swaging the copper tube to a predetermined gauge.

At block 630, the method 600 may include thermally annealing the copper tube and using Nip Rollers to roll the copper tube so as to create a smooth acoustic wire. The acoustic wire may be used in a voice coil, for example.

In methodologies directly or indirectly set forth herein, various steps and operations are described in one possible order of operation, but those skilled in the art will recognize that the steps and operations may be rearranged, replaced, or eliminated without necessarily departing from the spirit and scope of the disclosed embodiments. Further, all relative and directional references used herein are given by way of example to aid the reader's understanding of the particular embodiments described herein. They should not be read to be requirements or limitations, particularly as to the position, orientation, or use of the invention unless specifically set forth in the claims.

Furthermore, in various embodiments, the invention provides numerous advantages over the prior art. However, although embodiments of the invention may achieve advantages over other possible solutions and/or over the prior art, whether or not a particular advantage is achieved by a given embodiment is not limiting of the invention. Thus, the described aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

What is claimed is:

1. An acoustic wire, comprising:
a core extending along a longitudinal axis and comprising a carbon nanotube (CNT) copper composite; and
a copper layer circumscribing the core.

2. The acoustic wire of claim 1, wherein the core comprises a mixture of copper-coated CNTs and particulate of spherical copper powder aligned along the longitudinal axis.

3. The acoustic wire of claim 1, wherein a composition of the core is from forty to fifty percent carbon nanotube by volume.

4. The acoustic wire of claim 1, wherein the copper layer comprises a copper tube.

5. The acoustic wire of claim 4, wherein the copper tube is a 10100 oxygen-free high-conductivity (OFHC) copper tube and wherein the copper tube is subject to swaging operations.

6. The acoustic wire of claim 1, the acoustic wire forming at least a portion of a voice coil.

7. A method of forming an acoustic wire, comprising:
forming a core extending along a longitudinal axis, the core comprising a carbon nanotube (CNT) copper composite; and
forming a copper layer circumscribing the core.

8. The method of claim 7, wherein forming the core comprises:
using electrophoretic deposition to create the CNT copper composite, the CNT copper composite comprising of CNT-coated copper powder.

9. The method of claim 8, wherein using electrophoretic deposition comprises:
applying an electric field to charged CNTs dispersed in a solvent or aqueous medium so as to compel the charged CNTs to migrate towards a copper electrode.

10. The method of claim 9, wherein using electrophoretic deposition further comprises:
allowing the charged CNTs to collect and adhere to a surface of the copper electrode so as to form a CNT coating on the copper electrode.

11. The method of claim 7, wherein forming the core comprises:
creating a mixture of CNTs with spherical copper powder.

12. The method of claim 11, wherein forming the core further comprises:
alloying the mixture with silver.

13. The method of claim 11, wherein forming the core further comprises:
using electroless deposition to coat the mixture with copper to form a copper-coated CNT powder blend.

14. The method of claim 13, wherein using electroless deposition comprises:
creating a plurality of copper-coated CNT powder blends, each copper-coated CNT powder blend having a different ratio of copper to copper-coated CNTs.

15. The method of claim 14, wherein forming the core further comprises:
consolidating the plurality of copper-coated CNT powder blends via hot isostatic pressing or cold isostatic pressing to create a consolidated powder.

16. The method of claim 15, further comprising:
packing the consolidated powder into a copper tube.

17. The method of claim 16, wherein forming the copper layer comprising:
swaging the copper tube to a predetermined gauge.

18. The method of claim 17, wherein swaging the copper tube comprises:
thermally annealing the copper tube; and
using Nip Rollers to roll the copper tube.

19. The method of claim 13, further comprising:
packing the copper-coated CNT powder blend into a copper tube.

20. The method of claim 19, wherein forming the copper layer comprising:
swaging the copper tube to a predetermined gauge.

21. The method of claim 20, wherein swaging the copper tube comprises:
thermally annealing the copper tube; and
using Nip Rollers to roll the copper tube.

22. A wire, comprising:
a carbon nanotube (CNT) copper composite core; and
a copper layer circumscribing the core.

23. The wire of claim 22, wherein the core comprises a mixture of copper-coated CNTs and particulate of spherical copper powder.

24. The wire of claim 22, wherein a composition of the core is from thirty to sixty percent carbon nanotube by volume.

25. The wire of claim 22, wherein the copper layer comprises a copper tube.

26. The wire of claim 25, wherein the copper tube is a 10100 oxygen-free high-conductivity (OFHC) copper tube and wherein the copper tube is subject to swaging operations.

27. The wire of claim 22, the wire forming at least a portion of a voice coil.
